(19) United States
(12) Patent Application Publication
(10) Pub. No.: US 2020/0027573 A1
(43) Pub. Date: Jan. 23, 2020

(54) Directional Production of Composite Particles

(71) Applicant: Ruggero Maria Santilli, Palm Harbor, FL (US)

(72) Inventor: Ruggero Maria Santilli, Palm Harbor, FL (US)

(21) Appl. No.: 16/005,586

(22) Filed: Jun. 11, 2018

Related U.S. Application Data
(60) Provisional application No. 62/518,047, filed on Jun. 12, 2017.

(51) Int. Cl. G21B 3/00; G21B 1/05; G21B 1/21

(52) U.S. Cl. CPC G21B 3/008; H02P 29/40; G21B 1/21; G21B 1/05

(57) ABSTRACT

An apparatus for creating composite particles with nuclei and electrons in one or more bound states. The apparatus has a vessel containing a gas such as hydrogen, deuterium or helium at a predetermined pressure, and a pair of electrodes extending into the vessel. The positive electrode is separated from the negative electrode by an adjustable gap. One or more capacitors are connected to the electrodes to provide a DC discharge, causing an arc across the electrodes. The apparatus has a pump configured to circulate the gas at a predetermined flow rate through the gap between the electrodes. Discharging the capacitors creates an electrical arc across the gap that ionizes the gas, generating a plasma that includes composite particles having a nuclei and electrons in the one or more bound states.

### CROSS-REFERENCE TO RELATED APPLICATIONS

This application claims the benefit of and priority to U.S. Provisional Application 62/518,047 filed Jun. 12, 2017 which is incorporated herein by reference in its entirety.

### FIELD OF THE INVENTION

The present invention relates to methods and apparatus for the directional production of composite particles.

### BACKGROUND

Despite historical advances, the sciences and technologies of the 20th century have left unresolved a number of environmental and societal problems. One such shortcoming is difficulty in detecting nuclear weapons that may be smuggled in suitcases, containers, vehicles or placed underground. Fissionable material such as the Uranium 235 cannot be reliably detected with X-rays and other conventional 20th century technologies because they are permanently stable metals.

Another shortcoming in the current state of technology is due to the lack of new environmentally acceptable nuclear energies. Despite expenditures of billions of dollars over three quarters of a century, the so-called “hot fusion” has not achieved an industrially usable new nuclear energy because of uncontrollable instabilities at the initiation of nuclear fusions. The so-called “cold fusion” has equally not achieved to date industrially usable new nuclear energies. A primary obstacle is the so-called “Coulomb Barrier,” namely, the Coulomb repulsion between nuclei due to their positive charge, which repulsion is inversely proportional to the nuclear distance thus becoming extremely big at the time of nuclear contacts.

A third shortcoming in the current state of technology involves the difficulty in recycling radioactive nuclear waste. Radioactive nuclear waste comes from a number of sources, including nuclear power plants and obsolete nuclear weapons. At present huge volumes of radioactive nuclear waste are being stored around the world in large storage facilities. It is anticipated that these nuclear waste storage facilities will need to be managed for many hundreds of years in the future. The current state of technology for disposing of or neutralizing stored nuclear waste is sorely lacking.

### SUMMARY

Embodiments disclosed herein address the above stated needs by providing systems and methods for the directional production of composite particles. Embodiments disclosed herein deal with the methods and apparatus for the resolution of the problem of the Coulomb Barrier via the directional production of a flux of negatively charged particles that, as such, are attracted by nuclei, thus offering new possibilities to search for new clean nuclear energies.

### BRIEF DESCRIPTION OF THE DRAWINGS

The accompanying drawings, which are incorporated in and constitute part of the specification, illustrate various embodiments of the invention. Together with the general description, the drawings serve to explain the principles of the various embodiments. In the drawings:

FIG. 1 depicts the ionization of a gas into its nuclei and electrons.

FIG. 2 depicts the bonding of positively charged nuclei and negatively charged electrons with opposing magnetic polarities.

FIG. 3 depicts the neutral composite particles whose synthesis from an ionized gas is a first result of this embodiment.

FIG. 4 depicts the external coupling of two gears to illustrate the need in FIG. 3 of opposing spin.

FIG. 5 depicts the neural or charged composite particles whose synthesis from an ionized gas is a result of various embodiments.

FIG. 6 depicts the internal coupling of gears to illustrate the spin coupling of FIG. 5.

FIG. 7 depicts a new type of neutral composite particle synthesized by various embodiments.

FIG. 8 depicts yet another type of composite particle synthesized from an ionized gas by various embodiments.

FIG. 9 depicts an additional composite particle synthesized from an ionized gas by various embodiments.

FIG. 10 depicts an apparatus embodiment for the synthesis of neutral composite particles from an ionized gas.

FIG. 11 depicts a component of the embodiment of FIG. 10 for achieving the directional production of a flux of neutral composite particles.

FIG. 12 depicts an apparatus for controlling and adjusting the electrodes in accordance with various embodiments.

FIG. 13 depicts the first control panel for the embodiment of FIGS. 10, 11, 12.

FIG. 14 depicts the second control panel for the embodiment of FIGS. 10, 11, 12.

FIG. 15 depicts the first utility of the apparatus of this embodiment, given by the detection of nuclear weapons smuggled in a suitcase.

FIG. 16 depicts the third control panel for the embodiment of FIGS. 10, 11, 12.

FIG. 17 depicts an apparatus for processing of a suitcase containing a nuclear weapon or fissionable material.

FIG. 18 depicts an embodiment of a mobile apparatus for scanning underground for hidden nuclear weapons or fissionable material.

FIG. 19 depicts an embodiment of an apparatus for the irradiation of material with a flux of charged as well as neutral composite particles.

### DETAILED DESCRIPTION

Various embodiments disclosed herein deal with new and novel systems and methods for the directional production of composite particles. It should be recalled that the only stable particles existing in nature are the proton and the electron whose specifications are known to those of ordinary skill in the art. The methods and apparatus of the various embodiments include engineering means for the synthesis of new composite particles consisting of bound states of protons and electrons. One principle of the various embodiments is that, under suitable spin couplings, the proton and the electron experience a mutual attraction due to opposite charges and magnetic moments which, being proportional to the square of the distance, becomes proportional to 10̂(26) N at the mutual distance of the order of the size of the proton which is one Fermi=10 (−13) cm. The various embodiments involve additional novel effects for the enhancement of such a natural bond.

Particles synthesized in accordance with the various embodiments may be unstable. However, even such unstable particles have a mean life on the order of seconds or minutes, thus being amply sufficient for the intended industrial applications. By way of comparison, neutrons are synthesized in the cores of stars from protons and electrons. However, neutrons are unstable upon being isolated, and decay spontaneously in about fifteen minutes. Similar occurrences hold for the remaining composite particles synthesized according to the methods and apparatus according to various embodiments disclosed herein.

The various embodiments deal with methods and apparatus for the industrial production of a controlled, directional flux of neutral or charged bound states of protons and electrons by therefore offering realistic new possibilities of resolving the above indicated, well known, open problems, as well as permitting basically new industrial application, such as the scanning of mines to ascertain the percentage content of a given mineral, inspection of welding for security, and others indicated in the specifications.

The methods of various embodiments disclosed herein may include the following processes:

Process 1: The complete ionization of the Hydrogen, Deuterium, Helium or other gases resulting in a plasma composed by nuclei and electrons;

Process 2: The efficient and controlled synthesis of said plasma into neutral or charged composite particles; and

Process 3: The controlled flow of said particles in a preferred direction, so as to optimize utility.

A foundational concept pertaining to the various embodiments involves synthesis of the neutron from the Hydrogen in the core of stars. It is thought that stars initiate their lives as an aggregate of Hydrogen that grows in time via the accretion of Hydrogen in interstellar spaces, until the pressure in the core of the stars is such that the Hydrogen atom is “compressed” into the neutron according to the 1910 original conception by H. Rutherford.

The laboratory synthesis of neutrons from a Hydrogen gas has been done a number of times and it is nowadays known in scientific literature. However, in conventional laboratory methods the synthesized neutrons are released in all space directions, thus being inefficient for the scanning of baggage and soil or the irradiation of material.

At least some of the various embodiments deal with the synthesis of neutrons from a Hydrogen gas under the condition that said neutrons are emitted predominantly in one given direction in Euclidean space so as to maximize the utility in the scanning of baggage and soil or in the irradiation of material. The various methods and related apparatus for the directional synthesis of neutrons from a Hydrogen gas are then extended for the directional production of other neutral as well as charged particles.

Process 1 may be achieved via commercially available methods and apparatus essentially consisting in vessels containing the selected gas at a predetermined pressure while being traversed by DC arcs between internal electrodes. Known physical laws then allow the identification of the Voltage and Joules of the discharge achieving total ionization of the gas at the pressure considered.

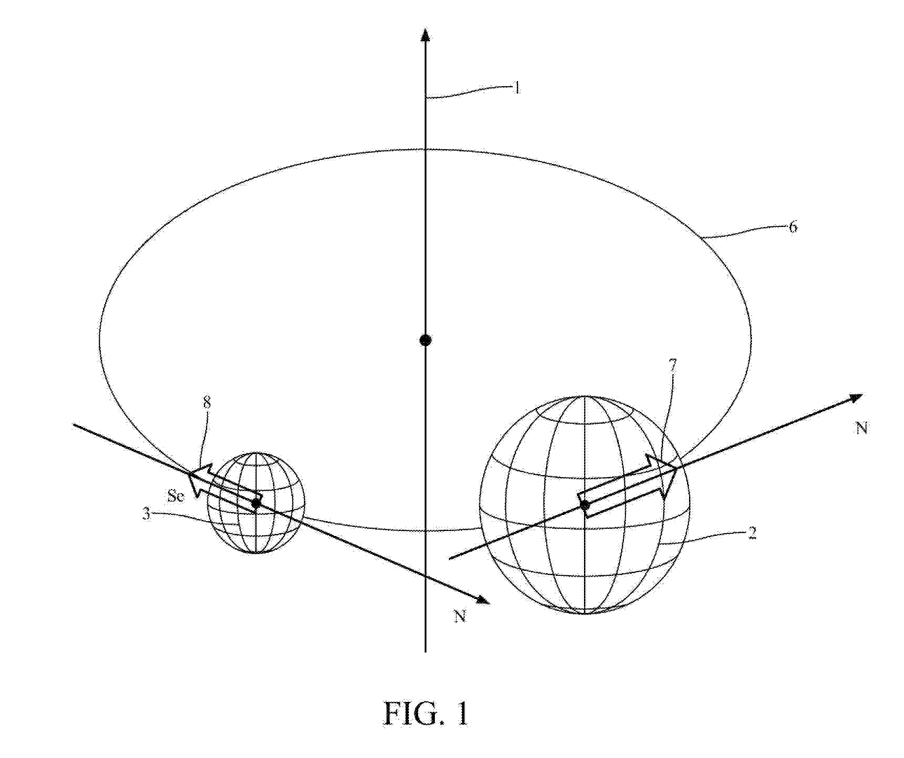

Process 2 may be achieved by traversing the plasma produced by Process 1 with a rapid DC arc, also called hereon a DC discharge, having in various embodiments typical values of substantially 15 kV and 2,500 J. With reference to FIG. 1, a rapid DC discharge 1 first ionizes the selected gas into nuclei 2 and electrons 3, and then aligns said nuclei and electrons with their magnetic moments 4 and 5 along the tangent to the local magnetic line 6 created by said DC Discharge. Said alignment is such to couple pairs of nuclei 2 and electrons 3 with opposite charges, opposite magnetic polarities 4, 5, and opposite spins 7, 8, at mutual distances on the order of their size, opposite charges and opposite spins 7, 8, thus setting up the premises for their desired synthesis into new composite particles.

Process 3 may be achieved in at least one embodiment via a controlled flow of the selected gas through the rapid DC discharge, in which case nuclei acquire a controlled value of linear momentum. Since electrons are at least two thousand times lighter than nuclei, the principle of conservation of the linear momentum acts such that the latter is maintained by the bound states of nuclei and electrons, thus resulting in the desired predominantly directional production of composite particles, where the predominant character is referred to the fact that the great majority of the synthesized particles are produced in the desired direction, while a minority of the synthesized particles is produced in other directions. In response, controlling the flow of the selected gas allows the reduction of the random production to a minimum.

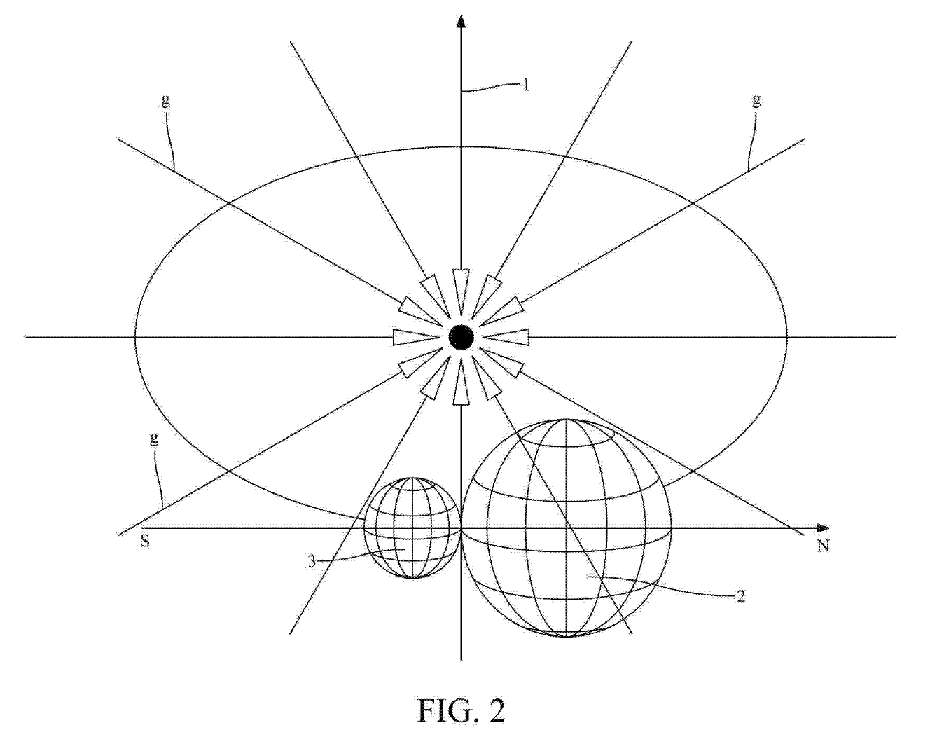

FIG. 2 depicts the bonding of positively charged nuclei and negatively charged electrons with opposing magnetic polarities. With reference to FIG. 2, the studies and experimentations by the inventor underlying this embodiment have established that the “disconnection” of a rapid DC discharge 1 creates a “compression” 9 of nuclei 2 and electron 3 against each other by therefore enhancing the bound state naturally caused by opposing charges magnetic polarities, and spins whose attractive force is proportional to 10̂{26} N at mutual distance of 10̂{−13} cm. The resulting bound state is evidently unstable. However, as here assumed to be known from particle physics, the indicated value of the strength of the bond implies that its mean life is on the order of seconds or minutes depending on specifications considered below, thus having clear utility because sufficient for irradiation of substances and other applications identified in various embodiments. By contrast, composite particle synthesized in conventional particle physics laboratories, such as the mesons, have half lives on the order of 10̂{−24} seconds, thus having no known utility.

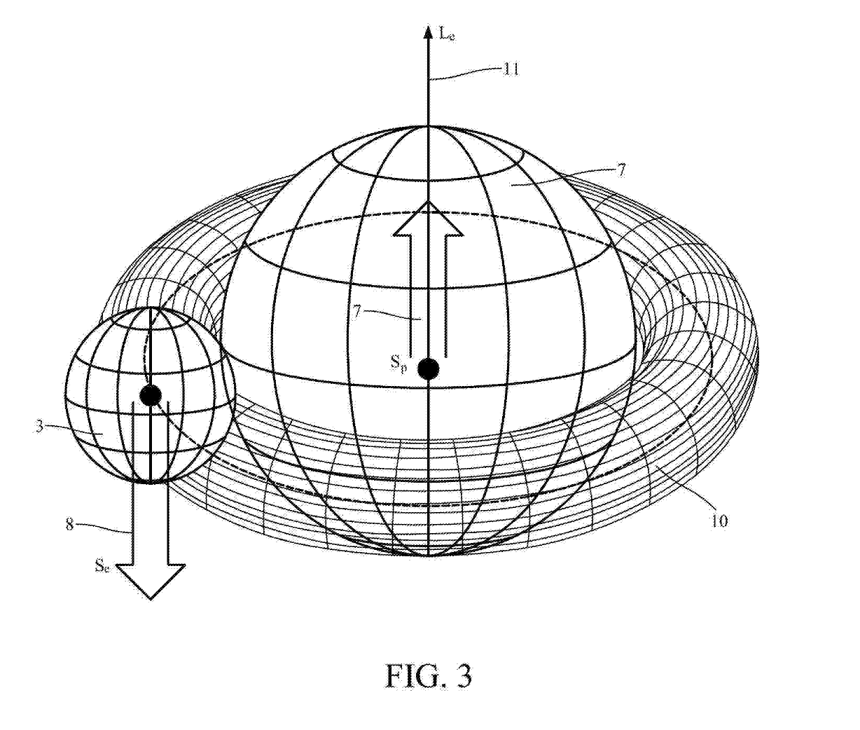

FIG. 3 depicts the neutral composite particles whose synthesis from an ionized gas is a first result of this embodiment. Under the configuration of FIG. 3 for the indicated values of Voltage and power, established knowledge in nuclear physics shows that the angular momentum 11 of the electron 3 around the nucleus 2 has null value for the ground state. Consequently, FIG. 3 depicts the creation of a new composite particle whose total angular momentum is the difference between the values 7 of the spin of the nucleus and value 8 of the spin of the electron. Similarly, the total charge is the difference between the nuclear charge and that of the electron.

For the simplest possible case, of using the Hydrogen as basic feedstock, the nucleus 2 is the proton with elementary positive charge +e and spin ½, while the electron 3 has the elementary negative charge −e and spin ½. Consequently, the synthesized particle depicted in FIG. 3 has null total charge and null spin. The resulting particles are known in the scientific literature under the name of “neutroids.” It should be recalled that said particles cannot be neutrons since neutrons have spin ½. Additionally, it is known in scientific literature that neutroids have the mass of 938.77 Million electron Volts (MeV) while neutrons have the bigger mass of 939.57 MeV. Finally, neutrons have a mean life of about fifteen minutes upon being isolated. By contrast, neutroids have a mean life on the order of one minute, thus being amply sufficient for applications.

The most salient difference between neutroids and neutrons is that commercially available neutrons detectors have been conceived and constructed to detect neutrons and, as such, they do indeed detect neutrons in view of the indicated differences in their characteristics. Nevertheless, neutroids have been experimentally established because they cause very specific nuclear transmutations. In fact, neutroids have been experimentally established by surrounding the apparatus used for their synthesis, hereinafter also called reactors, with suitable natural elements such as Silver or Gold, and activating the reactor for a sufficient time, such as for 30 minutes. Conducting spectroscopic analysis of said elements indicates the synthesis of neutroids. The detection of nuclear transmutations in said elements while no neutron was directly detected establishes the production of neutroids, as known in the scientific literature.

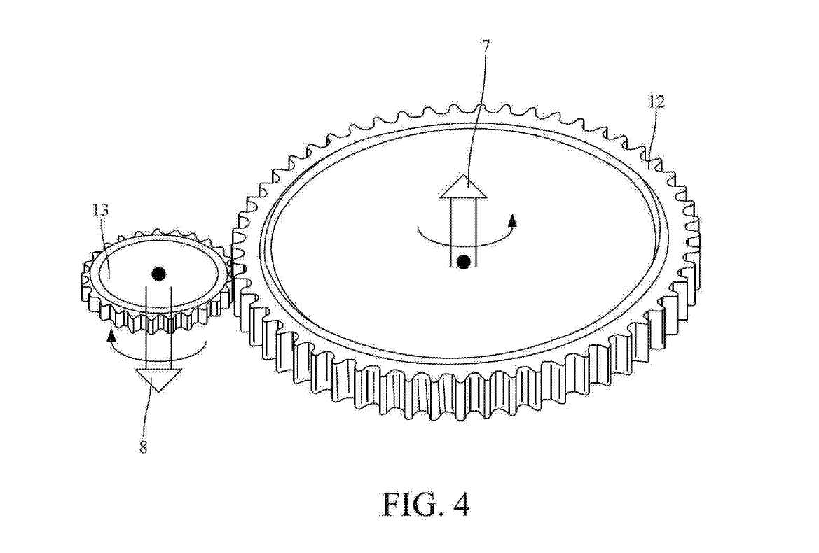

FIG. 4 depicts the external coupling of two gears to illustrate the need in FIG. 3 of opposing spin. FIG. 4 illustrates a novelty of this embodiment over conventional 20th century sciences and technologies pertaining to the bond of the proton and the electron into the neutroid. The bond is given by conventional, Coulomb, electric and magnetic attractions, plus a novel “contact” interaction, thus being similar to the coupling of gears 12 and 13 which coupling can only occur with opposing angular momenta, as well known by those of ordinary skill in the art, thus being fully parallel to the bond of FIG. 3. One novel aspect is given by the fact that, for the conventional 20th century sciences, both the proton and the electron must be represented as dimensionless points for compatibility with the used local-differential mathematics, in which case both spins parallel (called triplet coupling) and antiparallel (called singlet coupling) are possible, contrary to known physical evidence.

For the case of neutroids, we have conditions conceptually equivalent to the coupling of gears because the extended wavepacket of the electron 3 experiences a partial penetration into the charge distribution of the proton 2, resulting in contact interactions similar to those of gears. It then results that the coupling of the proton 2 and the electron 3 with parallel spins at mutual distances smaller than their size is extremely unstable, thus confirming the uniqueness of the indicated characteristics of the neutroid.

A novelty and consequential utility of the contact interaction is due to mutual penetration of the wavepackets of particles, and they are first illustrated by the fact that the neutroids cannot be formulated with conventional 20th century sciences since the latter admit that the smallest bound state of a proton and an electron is the ground state of the Hydrogen atom with radius on the order of 10̂{−8} cm. No bound state is admitted by quantum mechanics between a proton and an electron at mutual distances of 10{−13} cm, contrary to the experimental evidence that has established the existence of the neutroid.

In reality, the impossibility of describing the neutroid rests in the “mathematics” of conventional 20th century sciences because said mathematics is “local and differential,” thus solely permitting the representation of all particles as “point-like.” It is then evident also that, if the proton 2 and the electron 2 are represented as points, no bond of the type represented in FIG. 3 is conceivably possible.

In order to achieve a quantitative representation of the neutroid, as well as of the neutron and of other composite particles of various embodiments, the present inventor has first constructed a broadening of the mathematics of conventional 20th century sciences today known as “isomathematics” which is based on the generalization of the conventional associative product AB of generic quantities A, B (numbers, functions, matrices, etc.) into the associativity-preserving form A*B=ATB, where T is solely restricted to be positive definite but otherwise has an arbitrary functional, dependence. The realization T=Diag. (a, b. c, d) then allows the representation of the actual shape and density of particles since a. b. c can represent the semiaxes of a spheroidal ellipsoid, and d can represent the density. Isomathematics is then referred to the generalization of the entirety of applied mathematics of the conventional 20^{th} century into a covering based on the product A*B. The literature on isomathematics is rather vast and estimated to be in excess of 10,000 pages of published research and its primary sources can be easily identified via a search of the internet.

In passing to physical models, isomathematics implies a generalization of conventional mechanics into a new discipline known as “isomechanics,” which is novel in the representation of particles no longer as massive points but with their actual shape and density. Such a representation has then permitted a quantitative representation of the new bound state of FIG. 3. A knowledge of isomathematics and isomechanics is assumed for a person of ordinary skill in the art.

The uniqueness of the neutroid can be indicated by noting that its excited states are those of the Hydrogen atom because, in a vacuum, any excitation of the electron of the neutroid causes its transition to the quantized levels of the Hydrogen. Consequently, the “excited state” of the neutroids do not constitute any novelty.

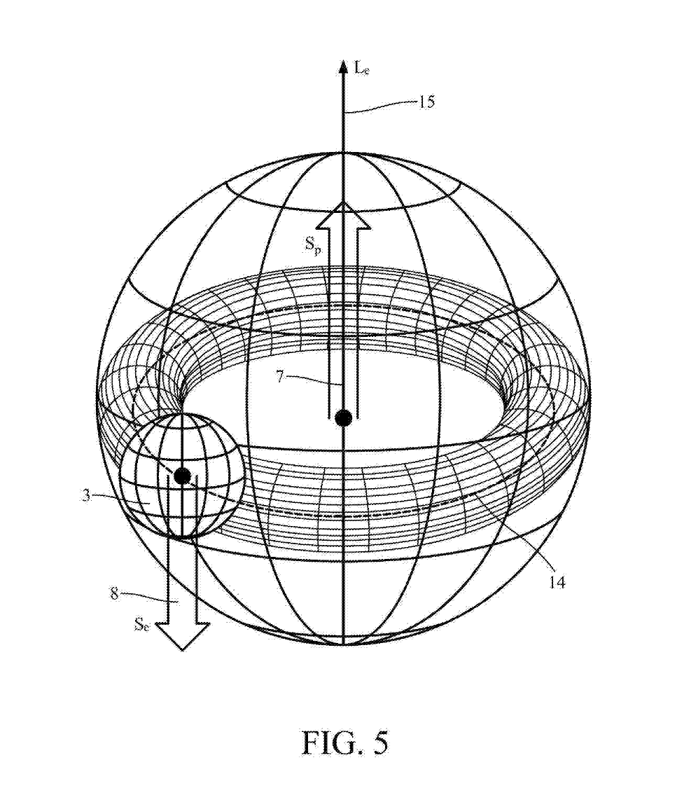

FIG. 5 depicts the neural or charged composite particles whose synthesis from an ionized gas is a result of various embodiments. Experimentations repeated by the inventor have established the existence of specific values of the voltage and energy of the rapid DC discharge, hereon also called “threshold values” and consisting of substantially 3 kV and 500 J. If the apparatus of various embodiments are used with values of the voltage and energy below the indicated threshold values, the apparatus synthesize neutroids. If the apparatus uses values of the voltage and energy sufficiently bigger than the threshold values, the compression of the electron 3 against the proton 2 is so strong that the electron entirely penetrates inside the proton, resulting in the new configuration of FIG. 5. A primary difference of the configurations of FIGS. 5 and 3 is that, in the latter configuration the electron orbits outside the proton, while in the former configuration the electron is forced to move within the proton.

The latter conditions imply that the motion of the electron inside the proton is “constrained” by the internal density to rotate with the proton spin. This constrain implies that, unlike the case of FIG. 3, the angular momentum of the electron 15 inside the proton is constrained to be equal to the proton spin 7. It then follows that the total angular momentum of the electron in the configuration of FIG. 5 is null and the total angular momentum of said configuration is ½. Extensive theoretical studies via the use of isomathematics and isomechanics have established that the bond of one proton and one electron according to the configuration of FIG. 5 represents “all” characteristics of the neutrons, including null charge, spin ½, mean life of about 15 minutes, charge radius of about 10̂{−13} cm, mass 939.57 MeV/ĉ2, and magnetic moment −0.966×10̂-26 J T̂-1.

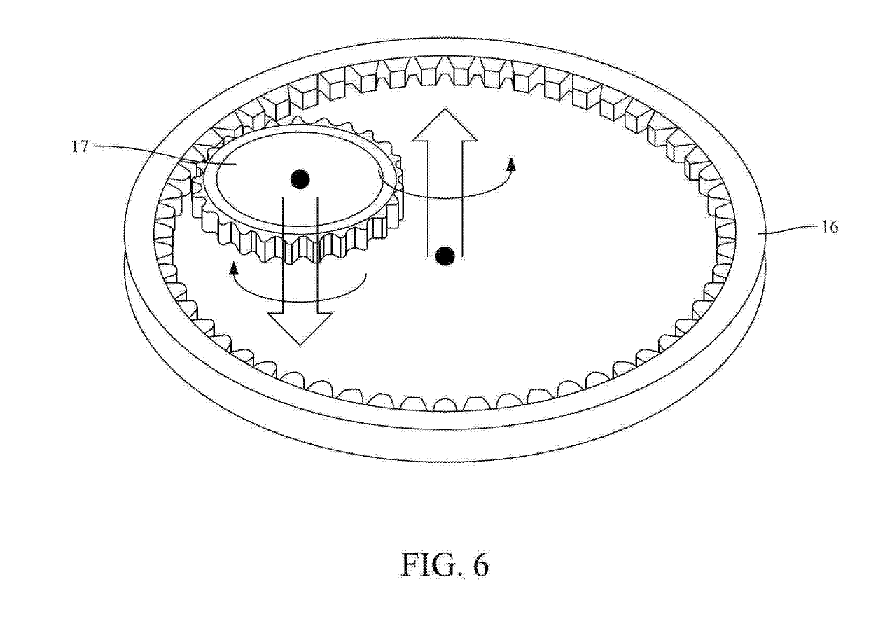

FIG. 6 depicts the internal coupling of gears to illustrate the spin coupling of FIG. 5. FIG. 6 illustrates the correspond configuration with gears in which the smaller gear 17 rotates this time in the interior if the big gear 16, also with antiparallel angular momenta for stable coupling under contact interactions. It should be noted that the force activating the synthesis of the neutron is radial “toward” the rapid DC discharge 1 and not away from the latter. This establishes that the synthesized neutrons are thermal, namely, they have low energies as needed for the utility of various embodiments to such an extent that the synthesized neutrons often remain trapped inside the reactor

The method for the synthesis of the neutron form a hydrogen gas via a rapid DC discharge has been experimentally established and confirmed by numerous experiments done by the inventor over a decade of tests and published in refereed scientific journals, which publications are hereon assumed as being known to a person to be skilled in the art.

Turning again to FIG. 5, it should be noted that the synthesis of the neutron according to the configuration of FIG. 5 is impossible for conventional 20th century sciences because, under said sciences, the electron cannot possibly be conceived inside the point-like proton. However, in the physical reality the proton is not only extended, but has a very large size per particle standards. Similarly, the electron has indeed a “point-like charge” but the inventor has indicated several times that “there exist no point-like wavepackets in nature.” In fact, the wavepacket of the electron has a size which is approximately the same as that of the proton charge distribution, thus requiring new formulations for their quantitative representation.

Recall that the prerequisite for any invention is “novelty,” which prerequisite in this case, refers to novelty with respect to the orthodox academia at large that, with numerous due exceptions, has no knowledge of the new isomathematics, isomechanics and the scientific literature on the synthesis of neutroids and neutrons from gaseous Hydrogen. Additionally, it is well known that orthodox academia opposes basic advances since they could jeopardize billions of dollars in research. Consequently, any appraisal for the various embodiments based on orthodox academia would violate basic rules for patentability.

As indicated earlier, following their syntheses, a number of synthesized neutrons remain within the plasma surrounding the DC discharge. With reference to FIG. 1, we can therefore consider the case of particle 2 being the neutron and particle 3 being the electron. FIG. 3 illustrates the bond of the electron, this time, with the neutron, resulting in a composite particle with “negative charge,” thus having far reaching utility for the elimination of the Coulomb barrier in nuclear fusions or transmutations.

If the rapid DC discharge has voltage and energy values below the indicated threshold values, also called “weak compression,” the resulting particle has spin zero, negative charge, mean life of milliseconds and it is known in the scientific literature under the name of the “pseudoprotoid”. If instead the rapid DC discharge occurs, voltage on the order of substantially 20 kV and energy on the order of substantially 3,000 J, also called “strong compression” is exerted, and the electron is compressed inside the neutron according to the configuration of FIG. 5, resulting in a new particle with negative charge −e, mass on the order as that of the-neutron, spin 1.2 and a mean life on the order of seconds, which particle is known in the scientific literature as the “pseudoproton.” The negative character of the charge of the pseudoproton is evidently crucial for the study of new esoenergetic nuclear transmutations and other applications since the pseudoproton is attracted by nuclei.

In summary, various embodiments establish the capability of synthesizing “negatively charged” composite particles with far reaching environmental and societal utility, such as their use for new environmentally acceptable nuclear energy, the stimulated decay of nuclear waste, and other applications in view of the fact that negatively charged composite particles are “attracted” by nuclei. The negatively charged composite particles experience the strong nuclear interactions in response to being in contact with nuclei, and cause basically new, esoenergetic nuclear transmutations some of which occur without the emission of harmful radiation and without the release of radioactive waste.

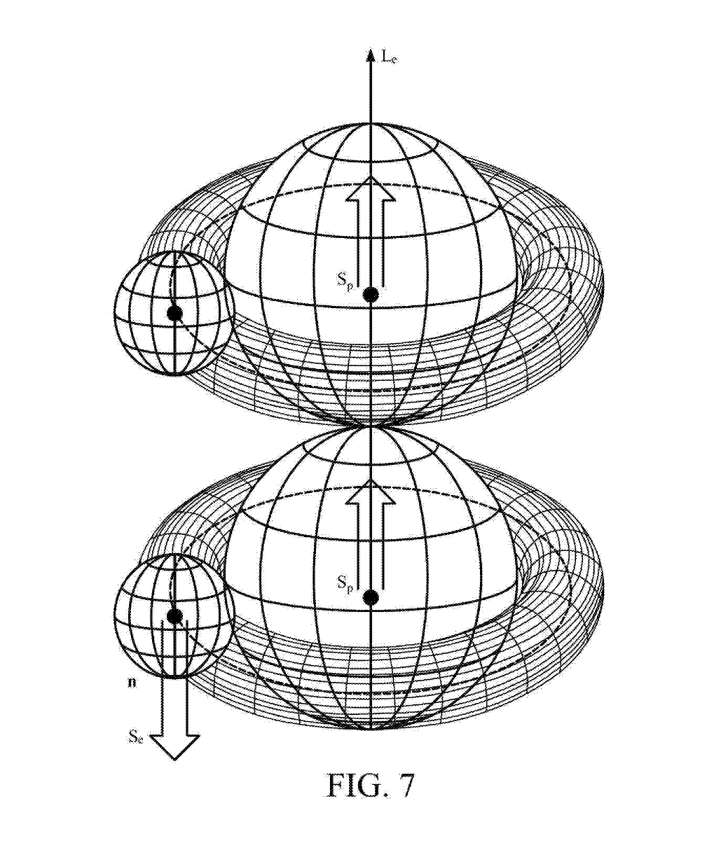

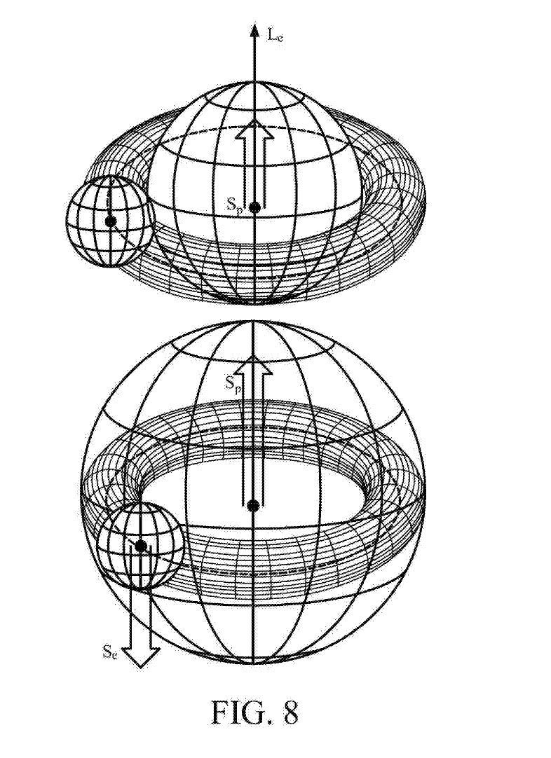

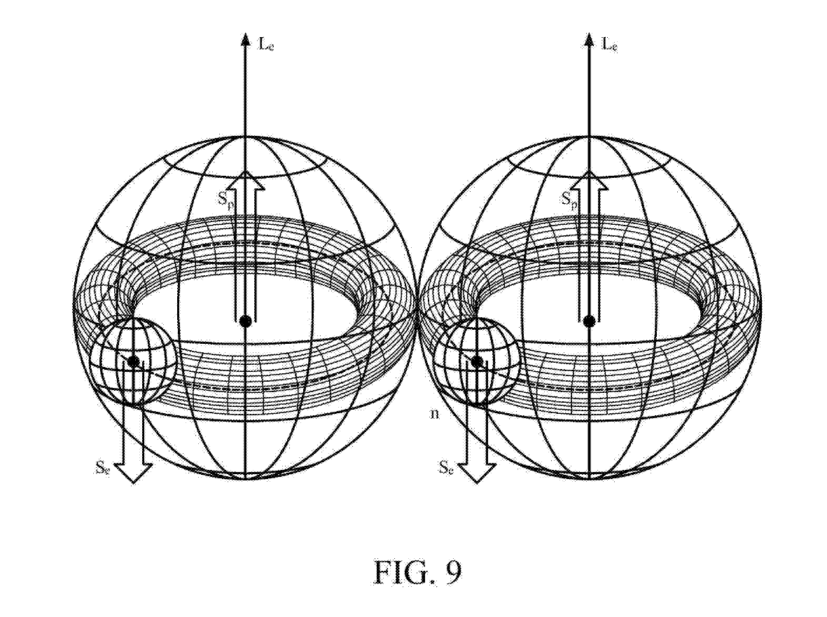

FIGS. 7-9 depict new types of composite particles synthesized by the various embodiments. The above identified syntheses of neutroids, neutrons, pseudoprotoids and pseudoprotons can be iterated as follows. Consider the use in various embodiments of a commercially available Deuterium gas instead of Hydrogen. In that case, with reference to FIG. 1, the ionization of said Deuterium gas creates a plasma comprising deuteron 2 with spin one and electron 3 spin one-half that, following the weak compression according to FIG. 2, creates a bound state of one deuteron and one electron possessing null total charge, spin one half, mass essentially equal to that of the deuteron, mean life on the order of milliseconds, which bound state is called “deutroid.” Its utility is evident. For instance, various embodiments may be used to stimulate the decay of radioactive waste. The reason for the total spin 1.2 is due to the fact that the alternative triplet coupling with spin 3/2 would be extremely unstable because equivalent to the coupling of gears of FIG. 4 with parallel spins.

The use in at least some embodiments of a strong compression turns the deuteroid into a bound state with null charge, mass essentially that of the deuteron, mean life bigger than that of the deuteroid, and spin one, which bound state is called “neutroid,” which is essentially characterized by the compression of the electron inside the neutron upon being a member of the deuteron. In this case, too the total angular momentum of the electron is null and the spin of the pseudo-deuteron is that of the deuteron. The utility of the neutroid over the deuteroid is evident from the increased mean life. Additional bound states with mean lives smaller than those of the deuteroid and neutroids are characterized by the compression of additional electrons, thus resulting in negatively charged composite particles called “pseudo-deuteroids” and “pseudo-neutroids,” respectively.

The above identified process can be additionally iterated via the use in various embodiments of Helium, in which case the plasma surrounding the rapid DC discharge is given by the nucleus of the Helium which is known as the alpha particle, and two electrons, the use of a weak and a strong compression then yields a variety of neutral or charged composite particles essentially having the mass of the alpha particle, mean lives on the order of nanoseconds, and spin 0, ½, 1, and 3/2.

In closing, it should be indicated that the maximal possible values of voltage and energy the strong compression are insufficient, by a factor of 10̂{−6,} to separate the deuteron, the alpha particle and other nuclei into protons and neutrons, as a result of which the entire energy of the rapid DC discharge is used for the considered synthesis of composite particles. By contrast, the use of voltages and energies sufficient for the indicated reduction to protons and neutrons would create nuclear effects such to disrupt the synthesis of composite particles of various embodiments.

Apparatus for the Production of a Flux of Neutral Particles

The method for the synthesis of neutral composite particles presented above may be insufficient for a number of practical applications because said composite particles are synthesized in all directions. The various embodiments present for the first time a method and an apparatus, also called embodiment, for the “directional” synthesis, also called production, of neutral composite particles in a predominant selected direction, including the production of a flux of neutrons, neutroids, and other composite particles identified in the specifications.

The physical law underlying various embodiments is the principle of conservation of the linear moment. Consequently, at least some embodiments are based on a flow of Hydrogen or other gas in response to passing through rapid DC discharges. Recall that the proton is 1800 times heavier than the electron. Therefore, in response to the proton being converted into the neutron or neutroid via the capture of an electron, the neutron or neutroid must move in the same direction and with the same kinetic energy as that of the original proton, plus small corrections due to the capture of the electron, in view of the conservation of its linear momentum, resulting in a flow of neutral charged particles in the desired direction. The same principle equally applies for the production of neutral charged particles from gases other than Hydrogen.

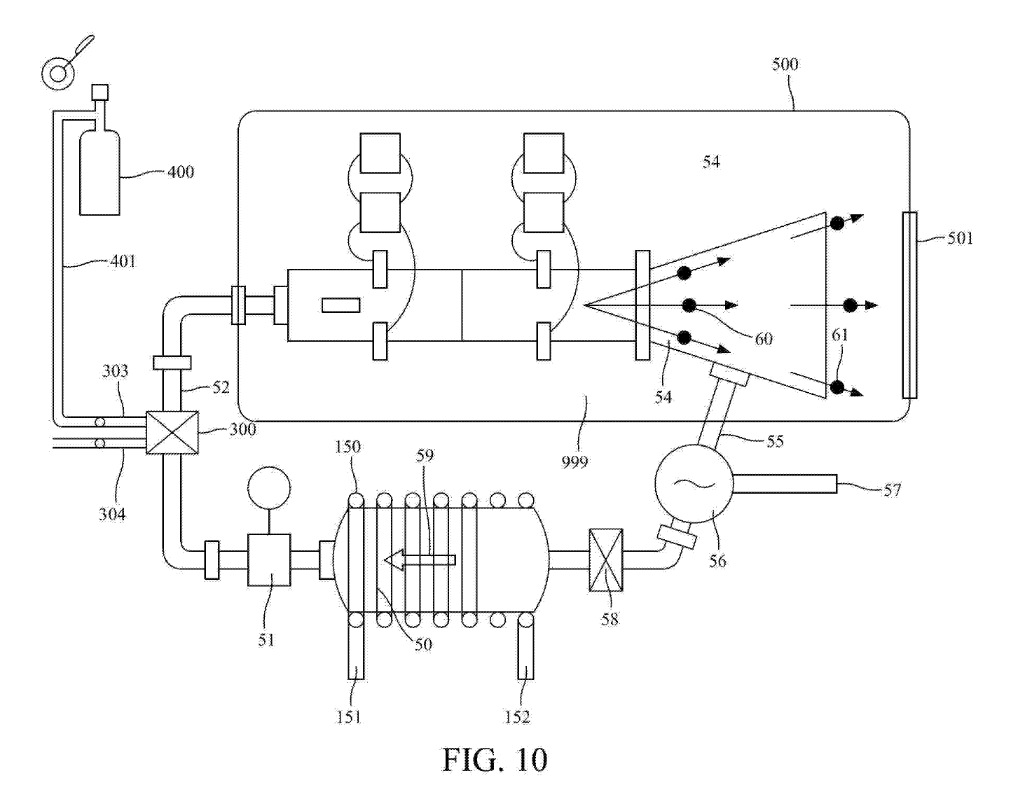

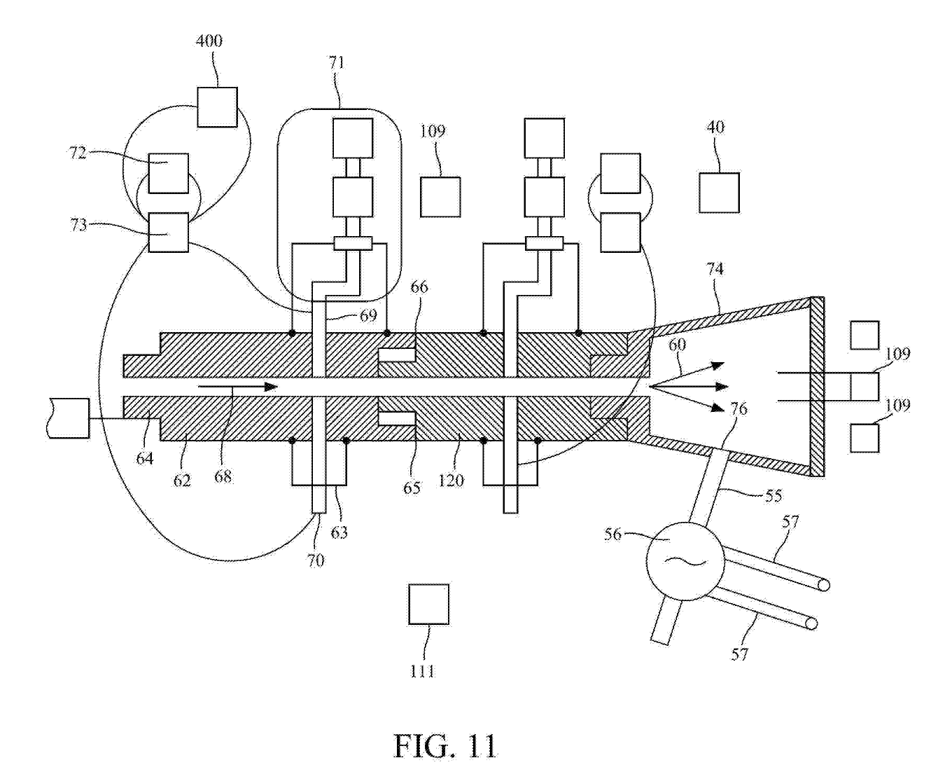

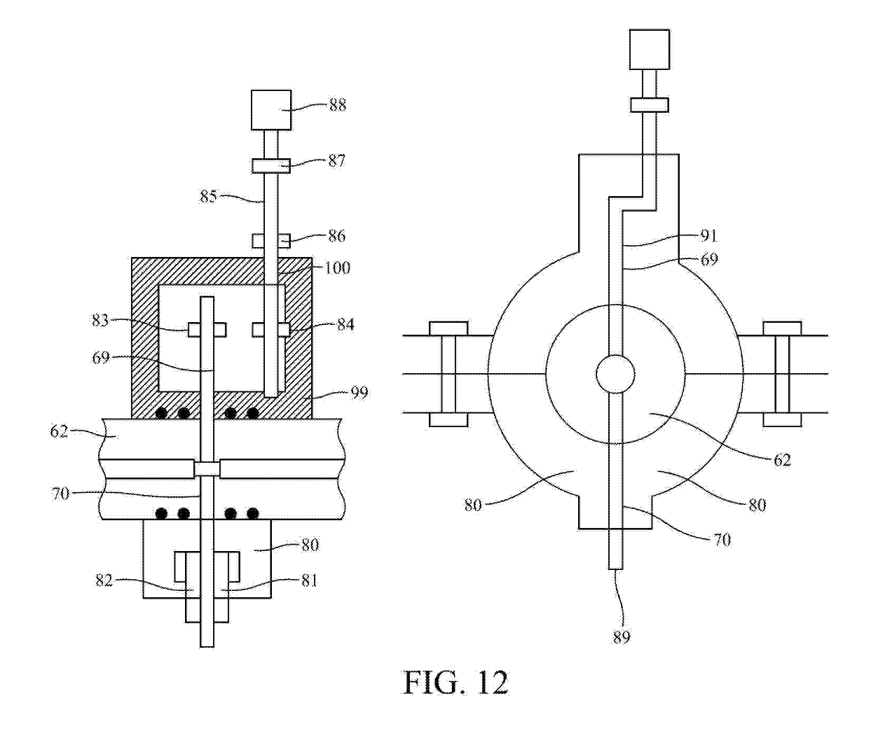

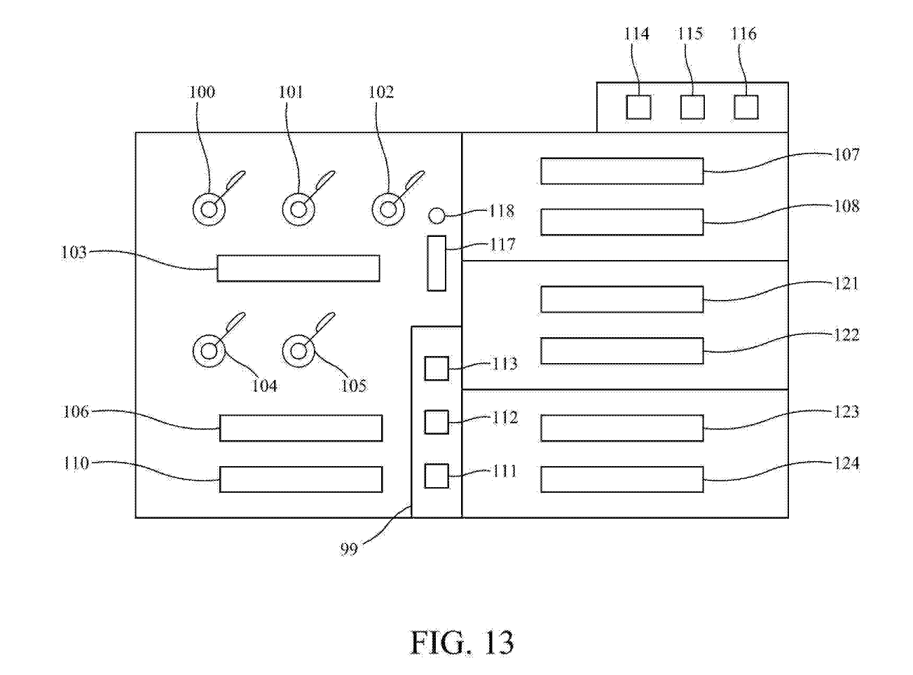

FIG. 10 depicts an apparatus embodiment for the synthesis of neutral composite particles from an ionized gas. The apparatus of FIG. 10 includes: a commercially available tank 50. The tank 50 may be configured a number of different ways, for example, having a 1′ diameter and T length, and be certified for containing hydrogen and other gases up to the predetermined pressure of 100 psi. The apparatus depicted in FIG. 10 may also have a pressure regulator 51 for the control of the existing flow of said gas, and a 1″ diameter gas pipe certified to hold said gas at 100 psi in the shape indicated in FIG. 10. One preferred directional particle source 53 enclosed in circle 500 is described below in detail and depicted in FIGS. 11, 12. The apparatus of FIG. 10 also has an existing port 53 from the directional particle source, with an additional 1′ diameter pipe 55 certified to contain Hydrogen or other gases up to 100 psi. The apparatus includes a pump 56 which may be powered by compressed air (whose compressor is not shown in the figure since compressors of the like are known to those of ordinary skill in the art). The pump may be certified for hydrogen and other gases and capable of circulating the Hydrogen or other gases at a predetermined rate of flow, for example, of up to 10 cf per minute, or in other embodiments of up to 25 cf per minute. The apparatus has an incoming pipe 56 for the compressed air from its compressor, as well as an outgoing pipe 57. The exemplary apparatus may also include a check valve 58. Check valve 58 allows the Hydrogen or other gases to flow at a predetermined rate in the indicated direction 59 but not in the opposite direction. The apparatus of FIG. 10 may be implemented with remote sensors and controls of all operations described in FIGS. 13, 14, 16.

FIG. 11 depicts a component of the embodiment of FIG. 10 for achieving the directional production of a flux of neutral composite particles. With reference to FIG. 11, at least one embodiment for the directional production of a flow of neutral composite particles of various embodiments includes, for example: the desired number of identical interlocking moduli 62 of which only two are illustrated in FIG. 11 because their increase would be known to those of ordinary skill in the art. The moduli may be made up of Lexan™ or similar insulating, strong and transparent material and machined out of a commercially available rod of 6″ diameter with each individual modulus having a length of 8″. Typically, transparent material is used for the moduli so as to allow the visual inspection at a distance for the presence or absence of an arc, for safety. The combined moduli 62 may be traversed by hole 63 of ¼″ diameter; said moduli 62 having a male thread to the leg 64 and a corresponding female thread 65 to the right of 2″ OD and 3″ length with thread as a consequence of which moduli 62 can be interlocked with seals 66 to prevent gas leaks. The male thread 64 of FIG. 11 may be connected via housing 67 to pipe 52 of FIG. 10 to allow Hydrogen or other gases to pass through hole 65 in the indicated direction 68. Modulus 62 of FIG. 11 includes electrodes 69, 70. The electrodes 69, 70, one of which is a positive electrode and the other a negative electrode, may be made up of tungsten ¼″ OD and 6″ length anode 70 being stationary while cathode 69 being axially movable via mechanism 71. Details of this are described in conjunction with FIG. 12, allowing the apparatus to control the gap between said electrodes. Each modulus 62 may be equipped with an electrical power unit 72 suitable to charge rapid discharged capacitors 72 whose terminals are connected to electrodes 69, 70. The interlocked moduli 62 ending with the terminal funnel 74 also made up of insulating, strong and transparent material such as Lexan™; funnel 74 may be sealed at its end by plate 75 of 3/16″ thickness, which is made up of an insulating, strong and transparent material such as Lexan™. The sealing may be realized via fasteners or other means known to those of ordinary skill in the art. The funnel 74 may be configured with a 1″ port 76 in order to connect the interior of moduli 62 to pipe 55 and pump 56 of FIG. 10 so as to allow continuous recirculation of the Hydrogen or other gases trough hole 68 in the interior of moduli 62 at a variable and controllable speed of up to 10 cf per minutes.

FIG. 12 depicts a mechanism for controlling and adjusting the electrodes in accordance with various embodiments. With reference to FIG. 12, at least one embodiment for the control of the gap between the electrodes 69, 70 includes, for example: flange 80 in the shape depicted in FIG. 12 with, for example, a 6″ internal diameter and 3″ thickness made up of insulating, strong and transparent material such as Lexan™. The flange 80 housing insert may be threaded 81 with seals 82 so as to lock anode 70 at a position with seals 82 to prevent leaks. The shaft of cathode 69 comprises gear 83 connected to a gear 84 housed on ¼″ steel rod 85 exiting flange 80 through seal 86 so as to prevent leaks. The steel rod 85 may be connected to stepper motor 88 or equivalent remotely controlled motor via box 87 consisting of insulating material of 3″ OF and 6″ length to insulate motor 88 from rod 85 under rapid DC discharges up to 20 kV and 100 mJ. Anode 69 may be free to slide axially in its housing, while rod 82 may be fastened to flange 80 via lower ball bearing 99 and upper bearing 100 so as to allow rotation but not axial motion. The high voltage electric wire 89 may be connected to the anode 70 and high voltage electric wire 91 may be connected to cathode 69. The wires 89, 90 may be connected to capacitors 73 of FIG. 10 pump 56, power unit 72, stepper motor 88, temperature gauge 999, pressure gauge 51, and other operation data being equipped with WiFi or other means known to those of ordinary skill in the art for the monitoring of all data via remote panels, 13, 14, 16 that are specialized per each modulus 73.

FIG. 13 depicts the first control panel for the embodiment of FIGS. 10, 11, 12. With reference to FIG. 13, the first remote control panel 99 of at least one embodiment may include, for example the two-position switch 100 for the movement forward and backward of cathode 69 via stepper motor 88, with dial 101 for the control of its speed and dial 102 for control of the torque so as not to cause internal damage. A dial 104 may be provided for control of the flow of air powering pump 56. Dial 105 is for controlling the flow of the gas to a predetermined rate in the interior of the embodiment, and digital reading 106 for controlling the flow of the gas to the predetermined rate. The embodiment may be completed by radiation detectors 109 placed in front of the funnel 74 as well as around the embodiment, as shown in FIG. 10. The radiation detectors may be connected with the control panel 99 via WiFi, infrared, or other electronic connection means, with remote readings 107 for neutron Counts per Second (CPS) and digital readings 108 for gammas CPS. FIG. 13 depicts only three of the radiation detectors 109 in remote panel 99 because their increase would be known to those of ordinary skill in the art. The panel 99 may include digital reading 110 of the gas pressure, light 111 for the automatic shut off of the operation in the event the internal gas pressure exceeds the predetermined value of 100 psi or other predetermined pressure (e.g., in the range of 25 psi to 200 psi), light 112 for the automatic shut-off in case the air pressure powering pump 56 is below or above operational values varying per each pump, and light 113 indicating automatic shutoff in case capacitors 73 are not charged. The panel 99 also includes main switch 114 for the activation of the compressed air powering pump 56, main switch 115 for the connection of power unit 72 to the grid, dial 116 for the control of the flow of the gas at a predetermined rate in the interior of various embodiments disclosed herein.

According to the experimentations conducted by the inventor, for the production of a flux of low energy neutrons and neutroids sufficient for the scanning of suitcases, containers and grounds, the gas in the interior of the embodiment remains generally below 200 degree F. Panel 99 includes digital reading 117 of the gas temperature, and alarm 118 in case said temperature exceeds 200 degrees F., in which case cooling system 150 of tank 50 is automatically activated via inlet 151 and outlet 152 connected to a cryogenic systems not shown in FIG. 10 because commercially available.

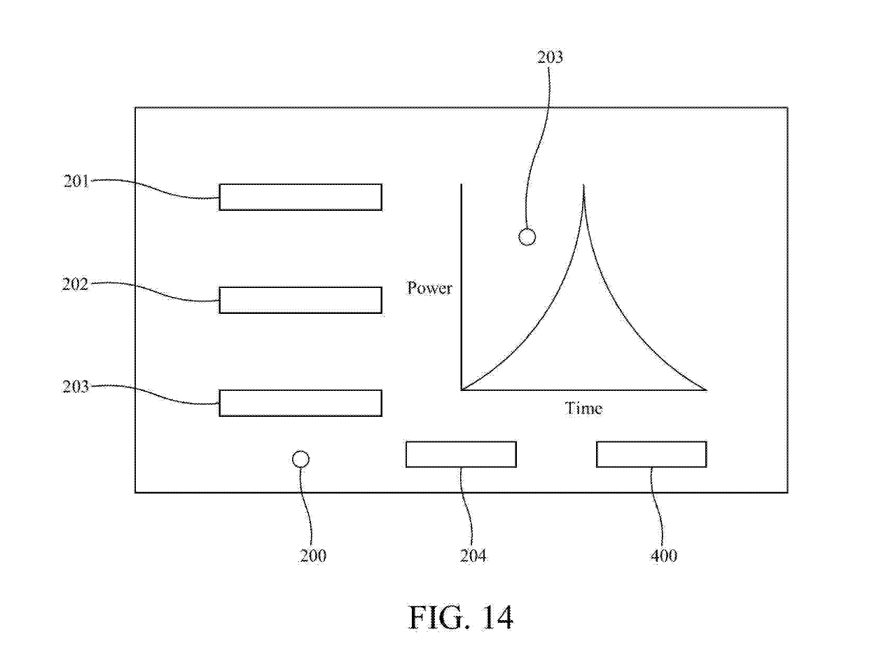

FIG. 14 depicts the second control panel for the embodiment of FIGS. 10, 11, 12. With reference to FIG. 14, the remote controls may be completed by second panel 200 for the controlling the width of the gap between electrodes 69 and 70, comprising digital view 201 for the voltage of the capacitors, digital view 202 for the Amperes of current absorbed by power unit 72 and digital view 203 for the amperes of the rapid DC discharge between electrodes 69 and 70. The remote panel 200 may also include a commercially available spectrometer providing view 203 of the rapid discharge, digital view 204 for the frequency of said rapid discharge per second. The remote panel 200 may be completed with electronic means (not shown) in the figure for setting up the gap between electrodes 69, 70 and for the delivering of a rapid discharge with the desired power and frequency that are set by said gap for given voltage and Joules of power unit 72.

Apparatus for the Production of a Flux of Neutral Particle

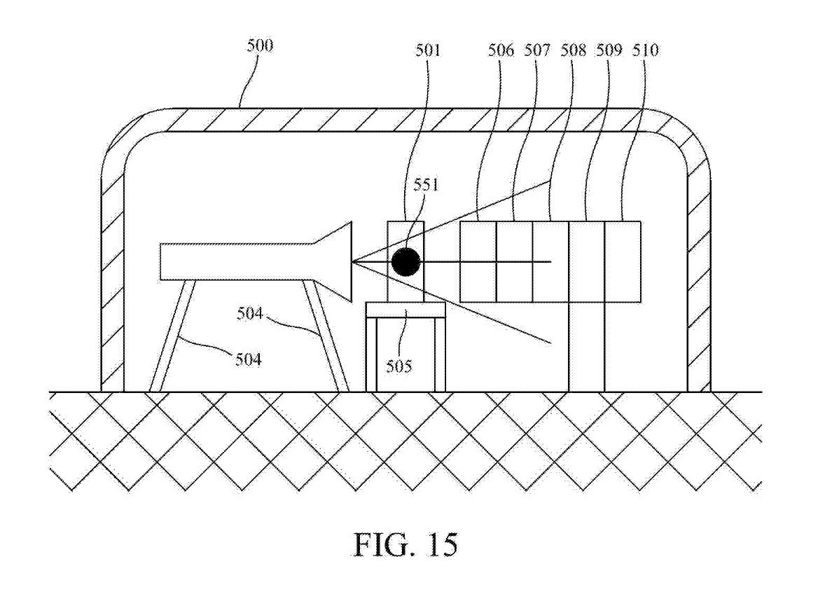

At the completion of its manufacturing and assembling according to the above specifications, the embodiment of FIGS. 10 to 14 is full of atmospheric air. It is tested as such, full of atmospheric air, according to the following interim. In one embodiment the following settings and measurements are implemented. Other settings and measurements may be implemented as well, in accordance with various embodiments. The gap between electrodes 69 and 70 may be set, for example, to 3/16″ via switch 100. The speed of the stepper motor 88 may be set at half of maximal value. The torque of said stepper motor may be set also at half of maximal value via dial 102. The compressed air powering pump 56 may be activated and electricity from the grid is supplied to power unit 72 via switch 106. Following 2 to 3 seconds, a visible DC arc in between electrodes 69, 70 is expected. In the event there is no arc between electrodes 69 and 70 from the charged capacitors 73, the electrode gap may be manually decreased via switch 100. The same operation is done for each additional modulus 62 since each modulus has its own power and control. Following the achievement of regular operations, the main switches 115 for electric power are switched off, in which case the gap control automatically brings them into short to discharge capacitors 73. The verification of the discharge of the capacitors is done via the related view in remote controls of FIGS. 14 and 15. Remotely controlled short 400 of capacitors 73 is additionally activated three sequential times to assure that capacitors 73 are discharged. The above interim should be repeated per each modulus 62. It should be noted that no harmful radiation is expected to be emitted by the proffered embodiment if operating at atmospheric temperature and pressure, and with atmospheric air. This allows the operator to be in the proximity of the apparatus for inspection,

After the achievement of the rapid discharge in between all electrodes of all moduli 62, the air pressure in the interior of the embodiment is increased via assembly 300 of FIG. 10 in line with pipe 52 comprising inlet pipe 301, outlet pipe 302 and related remote controlled valves 303 and 304. The embodiment may be tested, for example, first at 50 psi, by adjusting the gap between the electrodes since the frequency of DC arcs within gases is inversely proportional to their pressure. The embodiment may then be inspected for possible leaks. Air pressure inside the embodiment is increased to the operational value of 100 psi, the electrode gap is additionally corrected for the desired intensity and frequency of said discharges, and the apparatus is inspected for possible leaks, after which the electric power is disconnected from power unit 72, the capacitors are discharged, the air pressure operating pump 56 is disconnected, and all operations are halted. Following that, the pressure of the air inside the embodiment is brought to 300 psi, namely, three times the predetermined operating pressure, and the embodiment may then be again inspected for leaks. Possible leaks are corrected via standard procedures known to those of ordinary skill in the art, and the air pressure inside the apparatus is brought to atmospheric values. A final control is needed to assure the full integrity of the radiation shield 500 encompassing all moduli 62.

Following the above interim, the embodiment may be connected to pressure bottle 400 of commercial grade Hydrogen or other gas via inlet pipe 403, with pressure regulator 402 set at 50 psi. The air inside the embodiment is flushed out via valve 302 for three minutes after which valves 302 is closed, the interior of the embodiment may be brought to 50 psi, valve 303 is closed, and the bottle 400 is disconnected and moved away from the embodiment. The flow of the Hydrogen or other gas in the interior of the embodiment is then set at a predetermined rate of at least 5 cf per minute.

At this point, it is preferable that all operators, inspectors or bystanders be located at a distance of at least 100′ from the embodiment and all federal and state regulatory conditions for the operation of a neutron source are implemented, including the proper marking of the area with signs indicating radiation danger, physical barriers placed around the embodiment to prevent passer-by to accidentally come close to the neutron source, and other provisions, expected to be known to a person of ordinary skill in the art of neutron emissions, are implemented.

Following the above interim, the embodiment may be activated via main switches 114, 115 and all operations are monitored via remote panels 99 and 200, with particular attention to radiation detectors 109 placed in front of funnel 74 and related neutron CPS 107 and gamma CPS 108. Additional attention may be necessary for the additional radiation detectors 119 and 120 placed on the side of the embodiment, with neutrons and gamma counts visible in the respective digital readouts 121 to 125. The expectation is that the neutron COS emitted in the axial direction along funnel 74 are at least five times the neutron CPS emitted in a radial direction 119, 120. In the event this is not the case, the predetermined flow rate of Hydrogen or other gas should be increased from the initial value of 5 cf per minute up to 10 cf per minute, in which case neutron CPS in the axial direction toward funnel 745 are predicted to be at least ten times those in the radial directions 119, 120. Following assurance of continuous operations, the embodiment may be shut down via main switched 114, 115. The electrodes of all moduli 62 are placed on short and the lack of charge by the capacitors is confirmed via suitable short 400.

It should be indicated that the Lexan™ window 75 sealing funnel 74 is essentially transparent to a flux of neutral particles with about 10̂{-13} cm radius that exit funnel 74 in its axial direction. By contrast, all charged particles remain trapped inside the embodiment. However, pump 56 connected to funnel 74 sucks out all charged particles and, being part of an ionized gas, pump them into tank 50 where Hydrogen or other original gases are reconstructed by nature according to known physical laws, thus allowing a continuous recirculation of the gas through moduli 62, as requested by at least some of the various embodiments.

As indicated earlier, a primary use of various embodiments is the detection of nuclear weapons or fissionable material that could be hidden in suitcases, containers, vehicles, underground, or in other settings. Fissionable material such as the Uranium 235 cannot be reliably detected with conventional technology using X-rays or other conventional 20th century technologies because they are permanently stable metals. The present inventor recognized that the most reliable and effective method for their detection is a controlled flux of low energy (thermal) neutrons with a predominant direction toward the suitcase, container, vehicle, or ground to be scanned because fissionable material disintegrates upon being hit by low energy neutrons by releasing a shower of easily detectable radiations. The various embodiments deal with the method and apparatus for the controlled production of a controlled directional flux of low energy neutrons.

FIG. 15 depicts the first utility of the apparatus of this embodiment, given by the detection of nuclear weapons smuggled in a suitcase. As an illustration without limiting the utility of the various embodiments, and with reference to FIG. 15, the scanning of suitcase 501 on a conveyer belt 505 may be done by enclosing the entire embodiment depicted in FIG. 10 inside radiation shield 500 with exit funnel 63 directly in front of suitcase 501. Typically, the sole openings of shield 500 are the doors for the entrance and exist of suitcase 501 (besides emergency and service doors not shown in FIG. 15 since their inclusion is known to those of ordinary skill in the art). The embodiment of FIG. 15 is equipped with neutron detector 506, gamma detector 507, alpha detector 508, beta detector 509 and X-ray detector 510 placed immediately after suitcase 501 in the direction of the neutron flow.

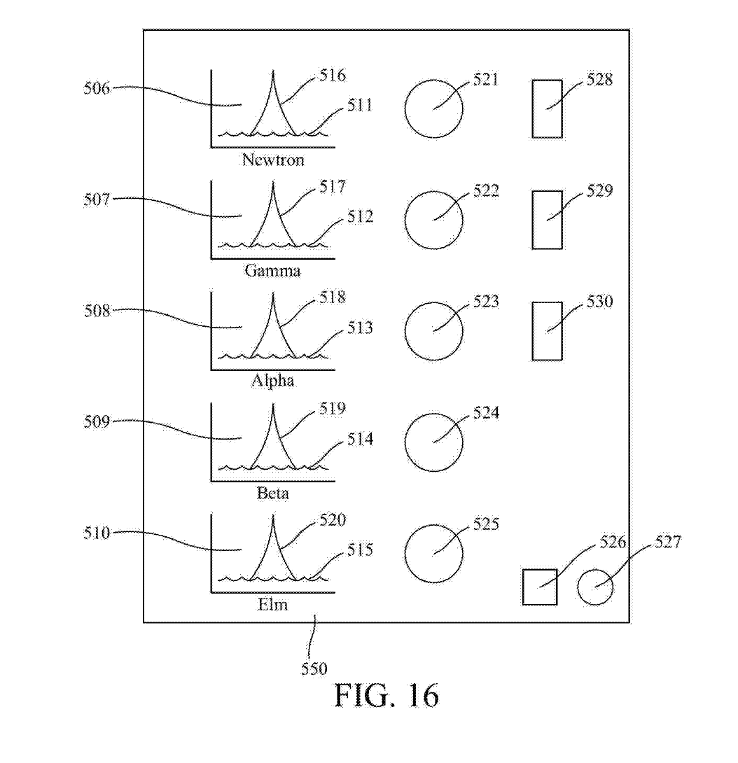

FIG. 16 depicts the third control panel for the embodiment of FIGS. 10, 11, 12.

With reference to FIG. 16, said detectors 506 to 510 are equipped with WiFi or other means for the transmission, of their readings to panel 550 inspected by the operator at a safe distance from the embodiment of FIG. 15, with the recording of neutron background reading 511, gamma background reading 512, alpha background reading 513, beta background reading and x-rays background reading denoting normal operations without any detection of fissionable material. In the event suitcase 501 contains fissionable material such as Uranium 835 551 while being scanned by the low energy neutron flux in accordance with various embodiments, a number of nuclei of said fissionable material 551 in number proportional to the neutron flow disintegrate according to known nuclear physics laws, with the release of a variety of radiations that are detected by radiation detector 506 to 510 and depicted with one or more corresponding peaks 516 to 520. In response to the detection of fissionable material one or more of corresponding alarms 521 to 525 are automatically sounded, conveyor belt 505 is automatically halted following the exit of suitcase 501 from shield 500.

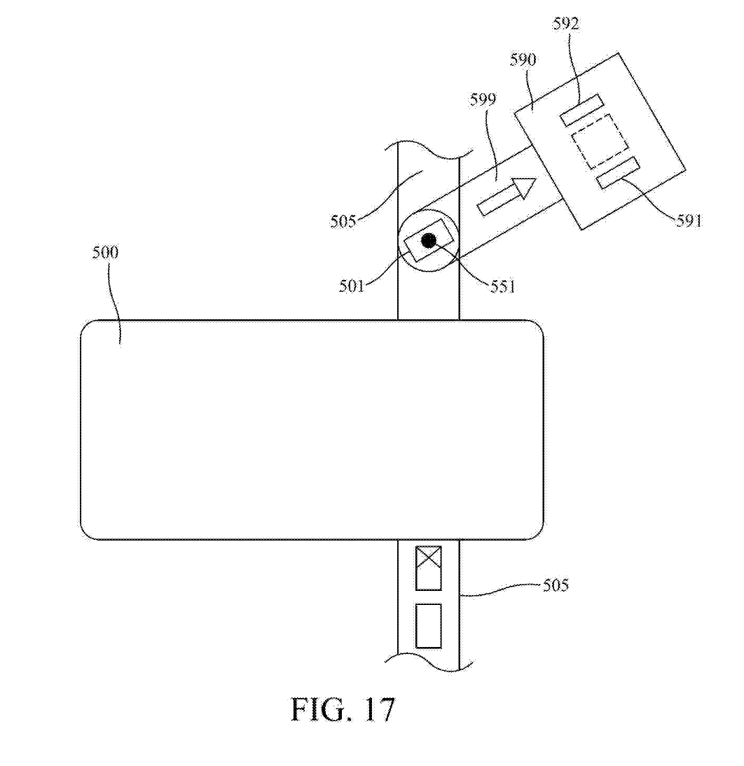

FIG. 17 depicts an apparatus for processing small objects such as a suitcase containing a nuclear weapon or fissionable material. With reference to FIG. 17, suitcase 501 with suspected fissionable material 550 is automatically transferred to new conveyor belt 500 and moved inside new shield 590 including additional radiation detectors 591, 592 where it is kept for the period of time for radiations to halt generally being on the order of fifteen minutes, after which suitcase 501 is inspected and fissionable material 550 is secured. Panel 550 of FIG. 16 includes additional detectors for the proper operation of the equipment in the surrounding of the directional neutron source of various embodiments, such as detector 576 of electromagnetic radiation and related alarm 577 which is automatically activated in the event shield 500 is in need of repair, or the directional neutron source is operated at such a power to emit electromagnetic radiations that could interfere with the operation of planes passing nearby. Panel 550 is finally equipped within additional controls for the complete halting of all operations, including disconnect 528 of power source 72 from the grid with automatic short of electrodes 69, 70, command 529 to activate remotely the independent short 400 of capacitors 73, disconnect 530 of the pump 57, and secondary controls known to those of ordinary skill in the art.

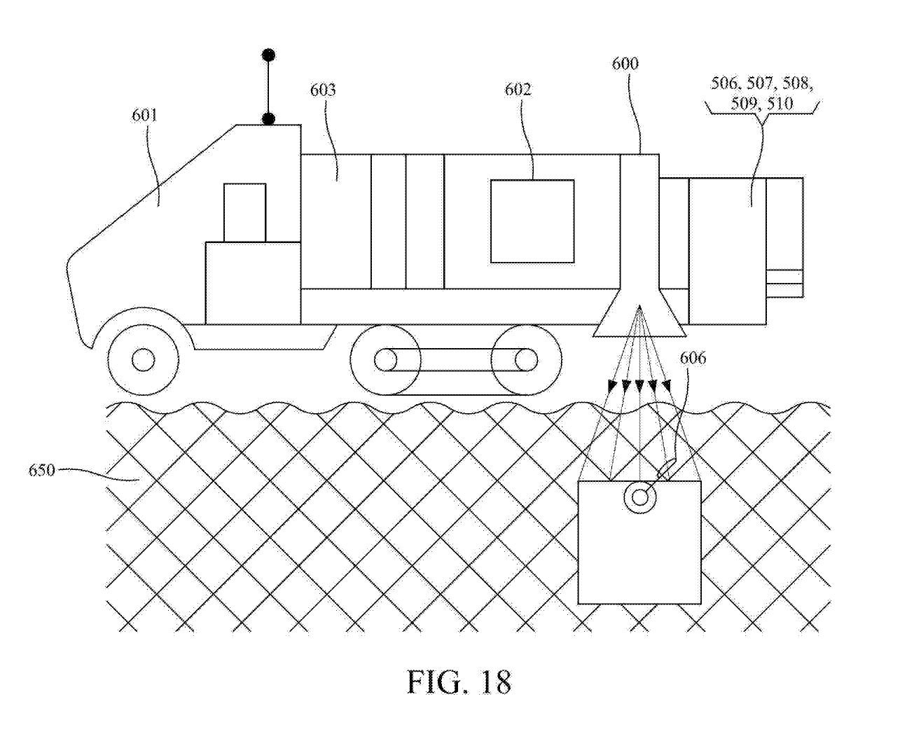

FIG. 18 depicts a mobile apparatus for scanning underground for hidden nuclear weapons or fissionable material. Without limiting additional utility of various embodiments, FIG. 18 illustrates another important use of the directional neutron flux of FIG. 10, this time for the detection of fissionable material that may be hidden under ground 65 such as the sand of a desert. For this purpose, at least some components of various embodiments may be entirely placed on the flatbed of a truck 601 including, for example: electric generator 601 powered by the same fuel powering truck 601, embodiment 602 including all operational parts of FIG. 10, directional neutron source 603 of FIG. 11 placed vertically toward the ground as shown in FIG. 18 with funnel 74 as closure to said ground as permitted by operation, and collections of detectors 506, 507, 509, 509, 510 placed next to directional neutron source 600. In the event a nuclear weapon or fissionable material 606 is hidden underground, upon be investigated by the vertically oriented neutron flux 651, the nuclear weapon or fissionable material 606 emits a variety of neutron, gamma, alpha, beta, X-ray and other radiations that are detected by detectors 506 to 510. Their reading may be sent via WiFi or other means to panel 500 of FIG. 16 with ensuing alarms 521 to 525. The area of the detection is marked via GPS coordinates for subsequent inspection by specialists and the remote scanning of the ground by the mobile embodiment for a flux of neutral particles.

Under rapid DC discharges between electrodes 69, 70 caused by capacitors 73 with substantially 15 kV and 20 mJ, the mobile embodiment of FIG. 18 identifies nuclear bombs or fissionable material hidden to the depth, for example, of no less than ten feet. However, at least some embodiments can be manufactured for dimensions much bigger than those indicated above, such as for rapid DC discharges at substantially 100 kV with 100 mJ, thus allowing the detection of nuclear weapons or fissionable natural at a depth up to one hundred feet in the case needed for national security. At least some embodiments for the production of a directional flow of neutral particles can also be manufactured for dimensions much smaller than the above indicated, yet with specifications sufficient to synthesize neutral particles from an ionized gas, including a shielded, hand operated equipment.

A large variety of additional embodiments are possible including those with the use of direct DC power without the intermediate use of capacitors, the use of AC discharges, the combined use of electric discharges and microwaves, the use of capacitors without continuous recharge for short terms uses. For example, one embodiment features one or more capacitor(s) connected to one of the two electrodes of each electrode pair with the other electrode of the pair being connected to ground. This allows the charge to flow from the capacitor(s) through the gap between the electrode pair, and to ground.

It should be stressed that the detection of smuggled nuclear weapons or fissionable material is only one of the applications of the various embodiments. An additional important application is that the use of the directional flux of charged particles for the stimulated decay of radioactive waste, the creation of new energies of nuclear type, and other applications expected to be the subject of continuations to this patent application. Nuclear waste is composed by, naturally unstable nuclei. Consequently, they are expected to admit stimulated decays, that is, means capable of reducing their mean lives from thousands of years down to minutes or days. It is argued that the controlled and directional flux of negatively charged particles of various embodiments has additional utility for the stimulated decay of radioactive nuclear waste because, as known in nuclear physics, their nuclei decay upon being irradiated with a suitable flux of negatively charged particles.

Additional embodiments are based on the ionization of the selected gas via any of the available means and then their synthesis into neutral charged particles via rapid DC discharges or other means. Yet a number of additional embodiments are based on means for the acceleration of protons and electrons other than those of the above disclosed embodiment, such as those based on the industrially available linear particle accelerators, and the synthesis of neutral charged particles.

Finally, it should be stressed that the above identified embodiments are referred to the production of a flux of “neutral” composite particles, thus including the production of a flux of neutroids, neutrons, and other neutral composite particles identified in the specifications. An additional application of the various embodiments is its use to identify the presence or absence of various natural elements in mines. It is well known in physics and expected to be known by those of ordinary skill in the art that, upon being irradiated with low energy neutrons, various natural elements, including precious metals, experience nuclear transmutations emitting gammas with specific characteristic frequencies. Therefore, the detection of gamma with said characteristic frequency establishes the existence of the corresponding natural element, and the number of gamma CPS of said frequency establishes the concentration of the element at hand.

As an illustration with reference to FIG. 18, for the purpose of identifying the Gold contained in a mine, the directional neutron flux of various embodiments can irradiate the soil of a tunnel of a mine, or the walls via a rotation of the device. In this case, the stable Gold isotope 79-Au-197 is transmuted into the unstable isotope 79-Au-198 that decays into 80-Hg-108 with the emission of a gamma with the 1.372 MeV plus the emission of a neutrino for the conservation of the angular momentum. The detection by the gamma detectors being part of at least some of the various embodiments of gammas with 1.372 MeV or, equivalently, of the corresponding frequency, establishes beyond doubt the presence of Gold in the scanned soil or wall because different natural elements would emit different gammas. The number of gamma CPS with 1.372 MeV, upon being calibrated with the background, provides information on the concentration of Gold in the scanned area of the mine. Fully equivalent results can be obtained to ascertain the concentration of other natural elements, in the ground or wall of tunnels in mines, or in surface soils. The utility of the various embodiments for the detection of natural elements over existing methods is clearly established by the fact that the embodiments provide instantaneous results in real time, while the pre-existing methods require days due to chemical analyses or other processes.

The utility of the various embodiments for environmentally acceptable new sources of nuclear energies is established by the fact that, upon being irradiated with a neutron flux, a number of stable elements experience transmutations into other elements by releasing a large amount of energy without the release of radioactive waste. As an example, the irradiation of 3-Li-7 with neutrons stimulates a number of transmutations whose final results are given by two natural element 2-He-4 plus 15.3 MeV=2.4×10̂(−12) J. The stimulated decay of 10̂(18) isotopes 3-Li-7 would then yield the considerable energy of 2.4×10̂(6) J without the emission of contaminants, since Helium is a natural element, and without the release of radioactive waste. The utility of the various embodiments is additionally established by the fact that the production of said energy is not restricted by time, and can occur over a selected period of time, thus allowing a 3 kW power unit to provide an acceptable flux of neutrons, resulting in a positive output of environmentally acceptable energy. Note that the above new form of clean nuclear energy is not currently available due to the current lack of availability of a directional and controllable neutron source, thus illustrating the novelty of the various embodiments.

The utility of the various embodiments for the recycling of radioactive nuclear waste, such as 137Cs, 90Sr, 99Tc, 239Pu, 241Am, is established by the fact that, upon being irradiated by a flux with at least 21,000 neutron CPS, radioactive nuclear waste decays in minutes into a variety of radiations and elements whose final form is stable. The recycling of nuclear waste is then done via their stimulated decay that turns their very long mean lives into short ones. The utility of the various embodiments is established by the fact that said stimulated decay of radioactive nuclear waste is not currently available due, again to the current lack of availability of a directional neutron source with the indicated characteristics.

Apparatus for the Production of a Flux of Charged Particle

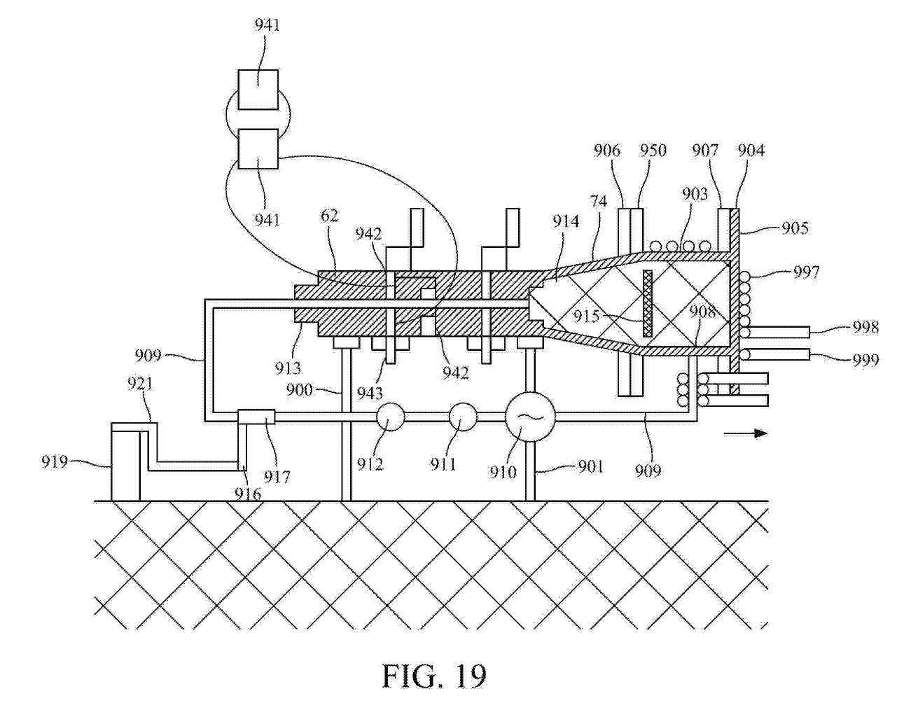

FIG. 19 depicts an embodiment of an apparatus for the irradiation of material with a flux of charged as well as neutral composite particles. As indicated in the specification, the efficient production of a flow of charged, composite particles required a new embodiment specifically designed and manufactured for the use of a flux of charged composite particles. Without limiting the utility of the various embodiments, FIG. 19 presents an implementation of one embodiment for the production of a flux of charged composite particles intended for the identification of its effect on sample materials as a premise for its industrial use. Other implementations and embodiments with various other dimensions and measurements may also be implemented in accordance with this disclosure. One implementation of an embodiment includes, for example: moduli 62 and funnel 74 horizontally positioned via supports 901 and 902; funnel 74 being extended with cylinder 903 of 12″ diameter and ¼″ thickness made up of Lexan™ or similar insulating, strong and transparent material, tube 903 having protrusions 950 for its fastening via nuts and bolts 906 to corresponding protrusion at the end of funnel 74 as well as fastening to terminal plate 905 with fastening means, 907 that are known to those of ordinary skill in the art; cylinder 903 comprising port 908 connected to pipe 909 that includes pump 910, check valve 911 and pressure regulator 911; pipe 909 being connected to the moduli 62 via port 913 so as to allow a continuous recirculation of the gas 914 through moduli 62; test natural 915 generally having the dimension of 6 square inches per 1/16″ thickness being placed vertically in front of funnel 74 as shown in FIG. 19; said embodiment being completed by power units 940 and capacitors 941 connected to electrodes 942 and 943 as in the embodiment of FIG. 11. Such an embodiment may be completed by the remote monitoring and control depicted in FIGS. 14, 15 and 16, shield 500, detectors 506 to 510 and other disclosure of the various embodiments for the production of a flux of central composite particles.

The operation of at least some embodiments for the production of a flux of charged composite particles is done at a remote distance. Such embodiments may comprise: testing the embodiment with gas 914 being composed by atmospheric air; flushing the air inside the apparatus with hydrogen, deuterium, helium or other gas via inlet port 916 connected to pressure bottle 919 with pressure gauge 920 and security valve 921 as well as exit port 917 for three minutes; closing valve 930 of exit port 916 and filling up the apparatus with the selected gas 914 to the pressure of 100 psi at which point bottle 916 is disconnected; activating pump 911 and power units 940 as in the embodiment for the production of a flux of neutral composite particles and irradiating sample material 915 for the desired period of time, generally for five minutes, after which gas 914 is removed from the interior of the apparatus via port 916 and 917 and replaced with atmospheric air via methods and procedures known to those of ordinary skill in the art, and irradiated sample 915 is removed for spectroscopic analysis of expected nuclear transmutations.

Various embodiments also deal with numerous additional implementations designed for the production and use of a flux of charged composite particles. An additional embodiment is given by the embodiment of FIG. 19 under an all encompassing shield 500 in which cylinder 903, retaliated flange 950 and terminal plate 905 are composed of refractive, heat-resistant material, the test sample 915 is given by pellets of radioactive nuclear waste, cylinder 903, flanges 950 and terminal place 905 being enclosed in a commercially available cryogenic cooling system 997 absorbing the heat produced by the stimulated decay of the radioactive waste for its usage via a commercially available heat exchanger through inlet port 998 and outlet port 999.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” “including” and/or “with” used in this specification specify the presence of stated features, integers, steps, operations, elements, and/or components, but do not preclude the presence or addition of one or more other features, units, steps, operations, elements, components, and/or groups thereof. The terms “obtaining” and/or “providing”, as used herein and in the claims, may mean either retrieving an item or receiving it from another person, user or business entity. The term “plurality”, as used herein and in the claims, means two or more of a named element. It should not, however, be interpreted to necessarily refer to every instance of the named element in the entire device—particularly, if there is a reference to “each” element of a “plurality” of elements. There may be additional elements in the entire device that are not be included in the “plurality” and are not, therefore, referred to by “each.”

The term “substantially” as used herein with reference to a value or amount means plus or minus ten percent (+/−10%) of that value or amount. The term “switchably connected” as used herein means that one component (e.g., a capacitor) is electrically connected via a circuit path to another component (e.g., an electrode) with a switch or relay in the circuit path that allows the circuit path to be controllably opened and closed. The phrase “rapid DC discharge” is used throughout the specification to describe the electrical discharge from the capacitor(s) in the apparatus. By “rapid” it is meant that the electrical energy stored in the capacitor(s) flows with virtually no resistance (or very little resistance) out of the capacitor to be applied to the electrodes in an amount sufficient to arc across the electrodes, as is known to those of ordinary skill in the art of capacitors.

The corresponding structures, materials, acts, and equivalents of all means or step plus function elements in the claims below, or that may be added to the claims below, are intended to include any structures, materials, or acts for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and gist of the invention. The various embodiments included herein were chosen and described in order to best explain the principles of the invention and the practical application, and to enable others of ordinary skill in the art to understand the invention for various embodiments with various modifications as are suited to the particular use contemplated.

1. An apparatus configured to create composite particles including nuclei and electrons in one or more bound states, the apparatus comprising:
a vessel containing a gas at a predetermined pressure;
a pair of electrodes including a positive electrode and a negative electrode extending into said vessel, the positive electrode being separated from the negative electrode by a gap;
a capacitor switchably connected to at least one of the positive electrode or the negative electrode;
a pump configured to circulate said gas at a predetermined flow rate through the gap between the electrodes; and
a source of power configured to charge said capacitor with a voltage and energy sufficient to deliver a DC discharge to one of the pair of electrodes of sufficient power to create an arc between the positive electrode and the negative electrode;
wherein said arc ionizes the gas, creating a plasma comprising the composite particles of said nuclei and electrons in the one or more bound states.

2. The apparatus of claim 1, further comprising:
means for adjusting the gap between said electrodes.

3. The apparatus of claim 1, wherein said predetermined flow rate is at least 5 cf per minute.

4. The apparatus of claim 1, wherein said predetermined flow rate is at least 10 cf per minute.

5. The apparatus of claim 3, wherein said pump is a variable speed pump capable of producing a plurality of predetermined flow rates including said predetermined flow rate.

6. The apparatus of claim 1, further comprising:
a plurality of capacitors including said capacitor;
a plurality of electrode pairs extending into said vessel, each of the plurality of electrode pairs being switchably connected to at least one of the plurality of capacitors, and wherein the plurality of electrode pairs includes said pair of electrodes.

7. The apparatus of claim 1, wherein said gas is hydrogen.

8. The apparatus of claim 1, wherein said gas is deuterium.

9. The apparatus of claim 1, wherein said gas is helium.

10. The apparatus of claim 1, wherein the one or more bound states includes a first bound state; and
wherein the composite particles in said first bound state each consist of a proton and an electron with null total charge and null total angular momentum.

11. The apparatus of claim 1, wherein the one or more bound states includes a second bound state; and
wherein the composite particles in said second bound state each consist of a proton and an electron with null total charge and spin one-half.

12. The apparatus of claim 1, wherein the one or more bound states includes a third bound state; and
wherein the composite particles in said third bound state each consist of a neutron and an electron with negative total charge and spin zero.

13. The apparatus of claim 1, wherein the one or more bound states includes a fourth bound state; and
wherein the composite particles in said fourth bound state each consist of a neutron and an electron with negative total charge and spin one-half.

14. The apparatus of claim 1, wherein the one or more bound states includes a fifth bound state; and
wherein the composite particles in said fifth bound state each consist of a deuteron and an electron with null total charge and spin one-half.

15. The apparatus of claim 1, wherein the one or more bound states includes a sixth bound state; and
wherein the composite particles in said sixth bound state each consist of a deuteron and an electron with null total charge and spin one-half.
